(19) United States
(12) Patent Application Publication
(10) Pub. No.: US 2017/0322973 A1
(43) Pub. Date: Nov. 9, 2017

(54) System and Method to Optimize Queries on a View

(71) Applicant: Huawei Technologies Co., Ltd., Shenzhen (CN)

(72) Inventors: Nirmala Sreekantaiah, Bangalore (IN); Dilip Kumar, Shenzhen (CN); Kumar Rajeev Rastogi, Bangalore (IN)

(21) Appl. No.: 15/646,818

(22) Filed: Jul. 11, 2017

Related U.S. Application Data
(63) Continuation of application No. PCT/CN2016/076629, filed on Mar. 17, 2016.

(30) Foreign Application Priority Data
Mar. 28, 2015 (IN) IN1607/CHE/2015

(51) Int. Cl. G06F 17/30

(52) U.S. Cl. CPC G06F 17/30451; G06F 17/30294; G06F 17/30463

(57) ABSTRACT

A system and method to optimize queries on a view comprise a processor coupled to a memory storing a plurality of instructions for directing the processor to receive a query comprising a part of query on view, check, based on the part of query on view, in system table, wherein the system table comprises a status associated with the view indicating the compilation of the view, and if the part of query on view found in the system table, fetch a shared object file storing at least one compilation function associated with the part of query on view, use the compilation function as a part of a query execution plan, and execute the query execution plan to display the result.

### CROSS-REFERENCE TO RELATED APPLICATIONS

This application is a continuation of International Application No. PCT/CN2016/076629, filed on Mar. 17, 2016, which claims priority to India Patent Application No. IN1607/CHE/2015, filed on Mar. 28, 2015. The disclosures of the aforementioned applications are hereby incorporated by reference in their entireties.

### TECHNICAL FIELD

The present subject matter described herein, in general, relates to database management systems, and more particularly to a system and method for improving the performance of query execution by optimizing queries on a view.

### BACKGROUND

A database system is generally used to answer queries requesting information from the database stored. A query may be defined as a logical expression over the data and the data relationships expressed in the database, and results in the identification of a subset of the database.

Any sequential query language (SQL) statement is processed by the relational database management system (RDBMS)parsing the SQL statement syntax to decide whether it conforms to the standard, checking whether the objects (tables, columns, etc.) used in SQL statement exist in database. This phase will extract any bind variable if there are any. Then, the database chooses the best plan for query execution based on cost and executes the best plan generates in previous step and returns the result.

In database theory, a view is the result set of a stored query on the data, which the database users can query just as they would in a persistent database collection object. This pre-established query command is kept in the database dictionary. Unlike ordinary base tables in a relational database, a view does not form part of the physical schema as a result set, it is a virtual table computed or collated dynamically from data in the database when access to that view is requested. Changes applied to the data in a relevant underlying table are reflected in the data shown in subsequent invocations of the view.

For all practical purposes, views can be treated as temporary tables. This ensures that a view has fixed schema and can be optimized in a way similar to tables.

In some non-SQL (NoSQL) databases, views are the only way to query data. Views can provide advantages over tables. Views can represent a subset of the data contained in a table. Consequently, a view can limit the degree of exposure of the underlying tables to the outer world; a given user may have permission to query the view, while denied access to the rest of the base table. Views can join and simplify multiple tables into a single virtual table. Views can act as aggregated tables, where the database engine aggregates data (sum, average, etc.) and presents the calculated results as part of the data. Views can hide the complexity of data. For example, a view could appear as Sales 2000 or Sales 2001, transparently partitioning the actual underlying table. Views take very little space to store, the database contains only the definition of a view, not a copy of all the data that it presents. Depending on the SQL engine used, views can provide extra security.

Just as a function (in programming) can provide abstraction, so can a database view. In another parallel with functions, database users can manipulate nested views, thus one view can aggregate data from other views. Without the use of views, the normalization of databases above second normal form would become much more difficult. Views can make it easier to create lossless join decomposition.

Query Execution on a View: Traditional query execution on a view (non-materialized) involves 3 steps. Rewriting the query by expanding the view definition, optimizing the complete query, and executing the complete query. Conventionally, to speed up query processing there are existing techniques which can compile queries to machine code on the fly. The queries can be compiled and persisted across database restarts too. It may be stored as shared object and linked during database startup. Further query invocation will use the compiled code. The compilation of the queries is further described in U.S. Pub. No. 2013/0198231, which is hereby incorporated by reference in its entirety.

Further, the table schema binding and compiled access may be achieved by the solutions from MICROSOFT which can compile tables to machine code. In these the table schema is compiled and persisted across database restarts. The existing techniques claim performance improvement by about 15 times on the database along with 5.1 times improvement in scaling from 2 to 12 cores. The compiling access methods to a table are further described in U.S. Pub. No. 2013/096894, which is hereby incorporated by reference in its entirety.

### SUMMARY

This summary is provided to introduce concepts related to a system and method to optimize queries on a view are further described below in the detailed description. This summary is not intended to identify essential features of the claimed subject matter nor is it intended for use in determining or limiting the scope of the claimed subject matter.

If a query involves a view, the query compilation is done during query planning/query execution time (on the fly). When a query is compiled, it is converted to machine code. If the compiled query is a sub-query of a larger query, machine code cannot be utilized as it cannot be hooked as a sub-query during planning/optimization. This is the case with views, where the view definition can be considered as sub-queries inside a larger query. If the filter conditions for a query change, it has to be recompiled. Otherwise the execution will be sub-optimal. This leads to the situation that for all queries involving views the query compilation is done during analyze and optimize phases. It is bad in cases where the view's definition is very complex. For example the view definition will consist of multiple join requests (JOINs), while the query itself only consists of a filter condition. The compilation of the JOIN is repeated each time a query on the view is executed.

The above technical problem will be solved by the present disclosure by providing a technique in which during creation of view, compile the relevant query contained in the view and corresponding access methods. This avoids the above mentioned technical problems and provides an efficient and effective solution with greater accuracy in the execution and results.

One aspect of the present disclosure is to compile the query that forms the view, when a view is created and then store information in system tables on the status of compilation.

Another aspect of the present disclosure is to create a structure that contains schema of the view as its elements.

Another aspect of the present disclosure is to generating access methods to access these elements based on the projections needed by the view.

Another aspect of the present disclosure is to convert the optimized query tree obtained after planning and optimized to a C function.

Another aspect of the present disclosure is to consider parameterization for each of the columns that form a part of view schema during the generation of the C function. This will ensure that any filter condition on the columns involving view can be executed optimally. Another aspect of the present disclosure is to compile the above function generated to generate a shared object and persisting it on disk.

Yet another aspect of the present disclosure is to, when a user query involving the view is issued, planner/optimizer looks up the status of compilation for view, skips the planning/optimizing the view part and directly invokes the function in shared object to run the query with the filter conditions as parameter to the function.

Yet another aspect of the present disclosure is to provide subsequent access to data, call the modified access methods in the shared object.

Still another aspect of the present disclosure is to provide an ALTER VIEW statement involves dropping the existing shared object, and recreating a new shared object and using it.

Accordingly, in one implementation, the present disclosure provides a data processing system implemented method of a processor coupled to a memory for directing a data processing system to process a query against data objects, the data objects being operatively coupled to the data processing system, the query including sub-queries, the sub-queries referencing the data objects, the data processing system implemented method comprises receiving a view creation query comprising a query definition, creating a view based on the view creation query received, compiling the query definition, wherein the compiling comprises forming a structure containing schema of the view and associated elements, thereby generating at least one compilation function, wherein the compilation function comprises access methods to access the associated elements based on the projections needed by the view, changing a status (a value indicating if the view is compiled or not) associated with the view in a pre-stored system table, and storing the schema of the view and the compilation function into a shared object file.

In one implementation, the present disclosure provides a data processing system implemented method of a processor coupled to a memory for directing a data processing system to process a query against data objects, the data objects being operatively coupled to the data processing system, the query including sub-queries, the sub-queries referencing the data objects, the data processing system implemented method comprises receiving a query comprising a part of query on view, checking, based on the part of query on view, in system table, wherein the system table comprises a status (a value indicating if the view is compiled or not) associated with the view indicating the compilation of the view, and if system table value states that view is compiled, fetching a shared object file storing at least one compilation function associated with the part of query on view, using the compilation function as a part of a query execution plan, and executing the query execution plan to display the result.

In one example, the status may be a flag indicating the view is compiled or not. For example, it may be in the form of FLAG ON or OFF, ON indicating view compiled and OFF indicating the view not compiled.

In one example, the status may be a value indicating the view is compiled or not. For example, it may be in the form of VALUE “0” or “1”, “0” indicating view not compiled and “1” indicating the view compiled.

In one implementation, the present disclosure provides a data processing system for processing a query against data objects, the data objects being operatively coupled to the data processing system, the query including sub-queries, the sub-queries referencing the data objects, the data processing system comprising a processor coupled to a memory storing a plurality of instructions for directing the processor to receive a view creation query comprising a query definition, create a view based on the view creation query received, and compile the query definition, wherein the compiling comprises forming a structure containing schema of the view and associated elements, thereby generate at least one compilation function, wherein the compilation function comprises access methods to access the associated elements based on the projections needed by the view, change a status (a value indicating if the view is compiled or not) associated with the view in a pre-stored system table, and store the schema of the view and the compilation function into a shared object file.

In one implementation, the present disclosure provides a data processing system for processing a query against data objects, the data objects being operatively coupled to the data processing system, the query including sub-queries, the sub-queries referencing the data objects, the data processing system comprising a processor coupled to a memory storing a plurality of instructions for directing the processor to receive a query comprising a part of query on view, check, based on the part of query on view, in system table, wherein the system table comprises a status (a value indicating if the view is compiled or not) associated with the view indicating the compilation of the view, and if the part of query on view found in the system table, fetch a shared object file storing at least one compilation function associated with the part of query on view, use the compilation function as a part of a query execution plan, and execute the query execution plan to display the result.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1A illustrates a flow chart for compilation of view, in accordance with an embodiment of the present subject matter.

FIG. 1B illustrates a flow chart for a query execution on view, in accordance with an embodiment of the present subject matter.

FIG. 2 illustrates traditional approach to obtain query tree using a traditional query compiler.

FIG. 3 illustrates the compilation of an expanded query into a shared object, in accordance with an embodiment of the present subject matter.

FIG. 4 illustrates a process of plan generation based on the shared object compiled, in accordance with an embodiment of the present subject matter.

FIG. 5A illustrates comparison of the traditional approach to obtain query tree using a traditional query compiler.

FIG. 5B the query tree generated by the query compiler considering the compiled view.

### DETAILED DESCRIPTION OF THE PRESENT DISCLOSURE

The following clearly describes the technical solutions in the embodiments of the present disclosure with reference to the accompanying drawings in the embodiments of the present disclosure. The described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The disclosure can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the disclosure may take, may be referred to as techniques. In general, the order of the steps of disclosed processes may be altered within the scope of the disclosure.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents. Numerous specific details are set forth in the following description to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

Systems, methods and apparatus to compile the relevant query contained in the view and corresponding access methods during creation of view, are disclosed.

While aspects are described for improving the performance of query execution by optimizing queries on a view may be implemented in any number of different computing systems, environments, and/or configurations, the embodiments are described in the context of the following exemplary systems, and methods.

The present disclosure discloses a system and method to create a view, based on the query received, and thereby compiling the query and corresponding access methods in the view.

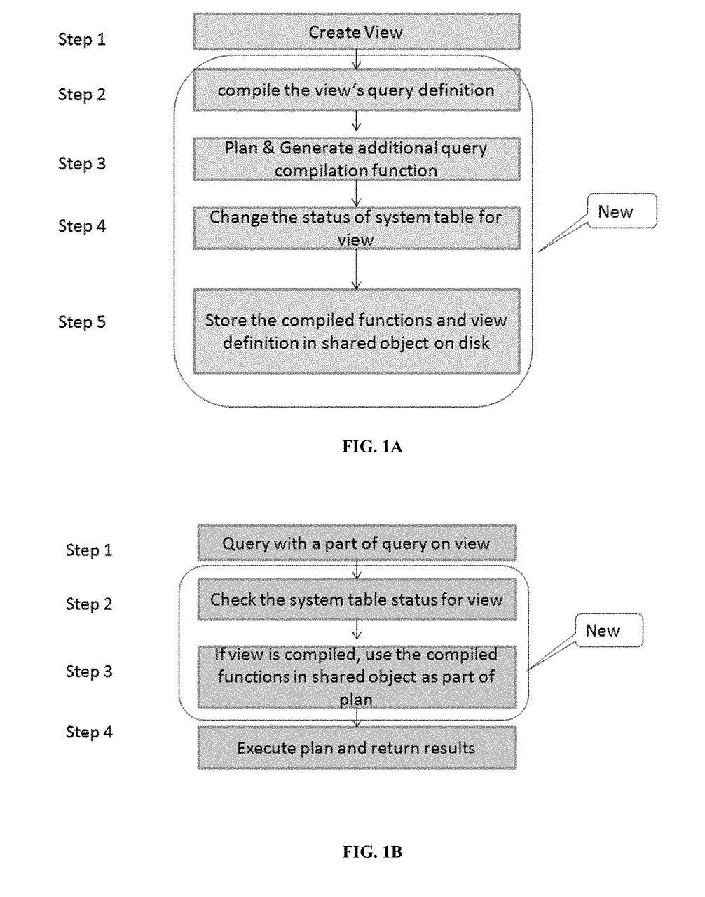

Referring now to FIG. 1A illustrates a flow chart for compilation of view, in accordance with an embodiment of the present subject matter. In one implementation, the present disclosure provides a data processing system implemented method of a processor coupled to a memory for directing a data processing system to process a query against data objects, the data objects being operatively coupled to the data processing system, the query including sub-queries, the sub-queries referencing the data objects, the data processing system implemented method comprises receiving a view creation query comprising a query definition, creating a view based on the view creation query received, compiling the query definition, wherein the compiling comprises forming a structure containing schema of the view and associated elements, thereby generating at least one compilation function, wherein the compilation function comprises access methods to access the associated elements based on the projections needed by the view, changing a status (a value indicating if the view is compiled or not) associated with the view in a pre-stored system table, and storing the schema of the view and the compilation function into a shared object file.

Referring now to FIG. 1B illustrates a flow chart for a query execution on view, in accordance with an embodiment of the present subject matter. In one implementation, the present disclosure provides a data processing system implemented method of a processor coupled to a memory for directing a data processing system to process a query against data objects, the data objects being operatively coupled to the data processing system, the query including sub-queries, the sub-queries referencing the data objects, the data processing system implemented method comprises receiving a query comprising a part of query on view, checking, based on the part of query on view, in system table, wherein the system table comprises a status (a value indicating if the view is compiled or not) associated with the view indicating the compilation of the view, and if system table value states that view is compiled, fetching a shared object file storing at least one compilation function associated with the part of query on view, using the compilation function as a part of a query execution plan, and executing the query execution plan to display the result.

The method as disclosed in FIGS. 1A and 1B may be performed by the data processing system. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the scope of the subject matter described herein. Furthermore, the method can be implemented in any suitable hardware, software, firmware, or combination thereof. However, for ease of explanation, in the embodiments described below, the method may be considered to be implemented in the below data processing system.

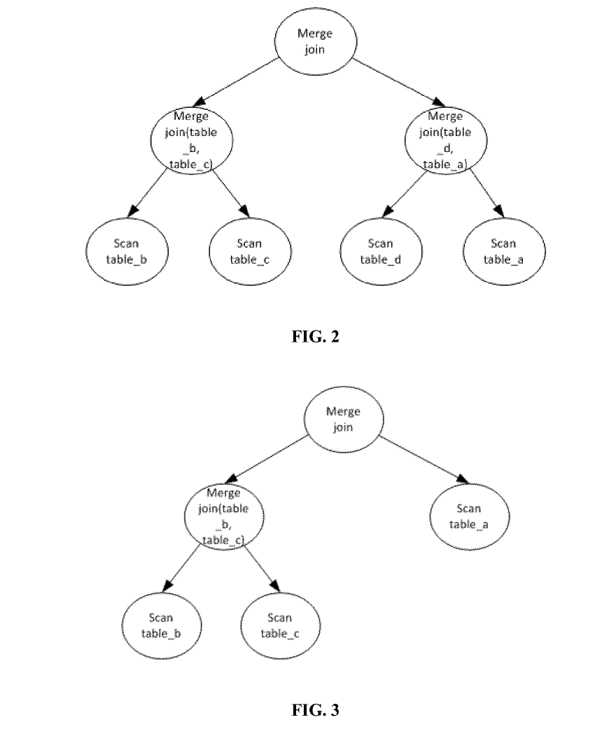

Referring now to FIG. 2, illustrates the process flow of the present disclosure, in accordance with an embodiment of the present subject matter. In one implementation, during creation of view, compile the relevant query contained in the view and corresponding access methods. When a view is created, compile the query that forms the view. Store information in system tables on the status of compilation.

Compilation involves creating a structure that contains schema of the view as its elements, generating access methods to access these elements based on the projections needed by the view, converting the optimized query tree obtained after planning and optimized to a C function. C function generation should consider parameterization for each of the columns that form a part of view schema. This will ensure that any filter condition on the columns involving view can be executed optimally. Compiling the above code generates a shared object and persists the shard object on the disk. When a user query involving the view is issued, planner/optimizer looks up the status of compilation for view, skips the planning/optimizing the view part and directly invokes the function in shared object to run the query with the filter conditions as parameter to the function. Subsequent access to data call the modified access methods in the shared object. ALTER VIEW statement involves dropping the existing shared object, and recreating a new shared object and using it.

The present disclosure is best explained with the help of below mentioned example, however it is to be understood that the example mentioned in the present disclosure is just for understanding purpose and not to limit the scope of the present disclosure in any way.

### EXAMPLE 1

### Query Without Filter:

Consider tables which are created as below
Create table table_a(a int);
Create table table_b(b int);
Create table table_c(c int);
Create table table_d(d int);

Consider the below view definition and a query which uses the view:
CREATE VIEW test_view AS SELECT a AS table_a.a, b AS table_b.b, c AS table_c.c FROM table_a, table_b, table_c WHERE table_a.a=table_b.b AND table_a.a=table_c.c
SELECT test_view.a FROM table_d, test_view WHERE table_d.d=test_view.a

Using a traditional query compiler we get the below query tree, as shown in the FIG. 2. Using view compilation the expanded query below is compiled into a shared object (lets say table.dll), as shown in the FIG. 3.

Table.dll will contain below structure for the compiled view

```
struct test_view{
    int a;
    int b;
    int c;
};
struct table_a{
  int a;
};
struct table_b{
  int b;
};
struct table _c{
  int c;
};
```

It will contain methods for scanning like below

```
  struct test_view* scan_test_view(int cond_num, struct test_view* conditions, int
filter_num, struct test_view* filters)
  {
      Call refresh_test_view
      Apply conditions on test_view
      Apply filters on result set to get the tuples
      Return tuples to caller
  }
  void refresh_test_view( )
  {
  struct *table_a TB_A;
  struct *table_b TB_B;
  struct *table_c TB_C;
  for all tuples of table_a, table_b, table_c{
      TB_A = deform_tuple_table_a( );
      TB_B = deform_tuple_table_b( );
      TB_C = deform_tuple_table_c( );
    if (TB_A.a == TB_B.b) && (TB_A.a == TB_C.c)
        form tuple as struct test_view and store it
  }
  }
```

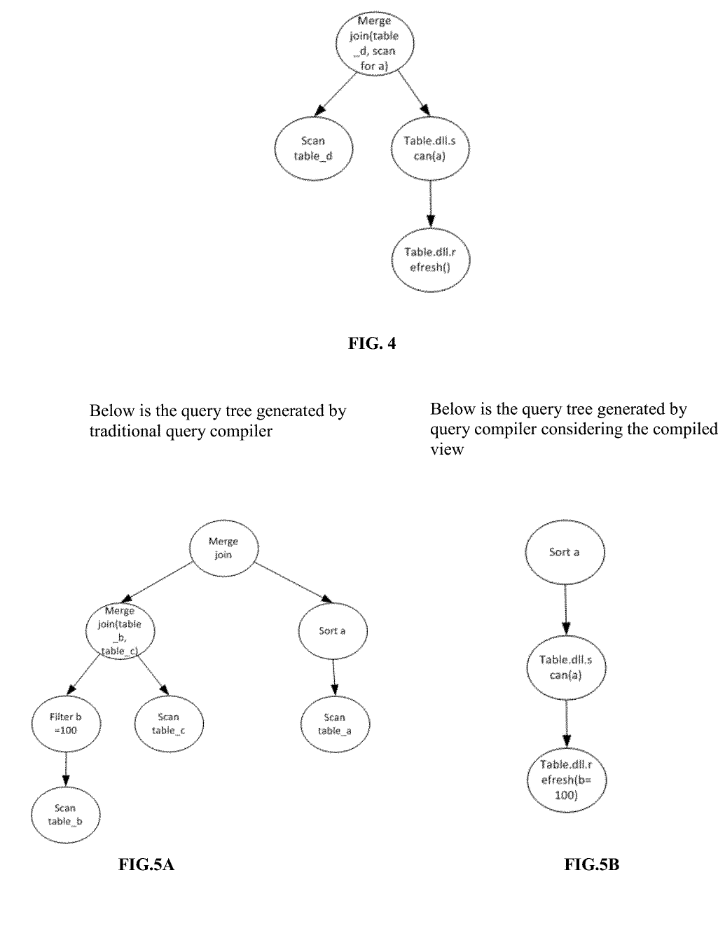

In above deform_tuple_XXX is considered as already available in compiled form. After view compilation, the query compiler uses the table.dll and generates plan as shown in FIG. 4.

### EXAMPLE 2

### Query With Filter:

Consider the below query which operates only on view and does not involve any other tables
SELECT test_view.a FROM test_view WHERE test_view.b=100 ORDER BY test_view.a

FIG. 5A illustrates comparison of the traditional approach to obtain query tree using a traditional query compiler and FIG. 5B the query tree generated by the query compiler considering the compiled view (as per the present disclosure).

It is to be noted that, sorting is currently not a part of the compiled code. Sorting along with some limited computations can also be pushed down to the compiled code.

In one implementation, the present disclosure provides a data processing system for processing a query against data objects, the data objects being operatively coupled to the data processing system, the query including sub-queries, the sub-queries referencing the data objects, the data processing system comprising a processor coupled to a memory storing a plurality of instructions for directing the processor to receive a view creation query comprising a query definition, create a view based on the view creation query received, and compile the query definition, wherein the compiling comprises forming a structure containing schema of the view and associated elements, thereby generating at least one compilation function, wherein the compilation function comprises access methods to access the associated elements based on the projections needed by the view, change a status (a value indicating if the view is compiled or not) associated with the view in a pre-stored system table, and store the schema of the view and the compilation function into a shared object file.

In one implementation, the present disclosure provides a data processing system for processing a query against data objects, the data objects being operatively coupled to the data processing system, the query including sub-queries, the sub-queries referencing the data objects, the data processing system comprising a processor coupled to a memory storing a plurality of instructions for directing the processor to receive a query comprising a part of query on view, check, based on the part of query on view, in system table, wherein the system table comprises a status (a value indicating if the view is compiled or not) associated with the view indicating the compilation of the view, and if system table value states that view is compiled, fetch a shared object file storing at least one compilation function associated with the part of query on view, use the compilation function as a part of a query execution plan, and execute the query execution plan to display the result.

In one implementation, when the view is created, the status of compilation is stored in system tables which comprises a location of the shared object file against the view.

In one implementation, the system creates, during compiling, a structure containing schema of the view as its elements.

In one implementation, the system generates access methods to access the elements based on the projections needed by the view.

In one implementation, the system plans the query to generate an optimized query tree.

In one implementation, the system converts the optimized query tree generated to include access function to access view.

In one implementation, when the query involving the view is issued, planner/optimizer looks up the status of compilation for view in the system table, skips the planning/optimizing the view part and directly invokes the function in the shared object to run the query with the filter conditions as parameter to the function, if the view is found matching in the system table.

In one implementation, a subsequent access to data calls the modified access methods in the shared object.

In one implementation, an ALTER VIEW statement involves dropping the existing shared object, and recreating a new shared object and using it.

In one implementation, the data processing system is communicably coupled with the user devices/database client systems (not shown). Although the present subject matter is explained considering that data processing system is implemented as a separate computing unit it may be understood that the data processing system may also be implemented on a server, in a variety of computing systems, such as a laptop computer, a desktop computer, a notebook, a workstation, a mainframe computer, a server, a network server, and the like. It will be understood that the data processing system may be accessed by multiple users through one or more user devices/client systems collectively referred to as user systems hereinafter, or applications residing on the user devices (not shown). Examples of the user devices may include, but are not limited to, a portable computer, a personal digital assistant, a handheld device, and a workstation. The user devices are communicatively coupled to data processing system through a network (not shown).

In one implementation, the network may be a wireless network, a wired network or a combination thereof. The network can be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

In one implementation, the data processing system may include the processor which may be implemented as one or more microprocessors, microcomputers, microcontrollers, digital signal processors, central processing units, state machines, logic circuitries, and/or any devices that manipulate signals based on operational instructions. Among other capabilities, the processor is configured to fetch and execute computer-readable instructions stored in the memory.

The interface may be provided to the data processing system that may include a variety of software and hardware interfaces, for example, a web interface, a graphical user interface, and the like. The interface may allow the client systems/users to interact with a user directly or through the apparatus and the system. Further, the interface may enable the apparatus to communicate with other computing devices, such as web servers and external data servers (not shown). The interface can facilitate multiple communications within a wide variety of networks and protocol types, including wired networks, for example, LAN, cable, etc., and wireless networks, such as WLAN, cellular, or satellite. The interface may include one or more ports for connecting a number of devices to one another or to another server.

The memory may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory may include at least one query compiler configured to prepare an execution plan in a tree structure, with a plurality of plan nodes, for the database query received. It shall be noted that the query compiler is a conventional compiler and the execution plan generation done in the tradition/convention approaches as available in the prior-art.

Exemplary embodiments discussed above may provide certain advantages. Though not required to practice aspects of the disclosure, these advantages may include

The mechanism disclosed in the present disclosure improves the planning and optimization time for queries on the view.

The mechanism improves on fly query compilation becomes faster which is an important criteria for dynamic query compilation.

The mechanism improves the query execution time for queries on view.

The mechanism compiles the relevant query and access methods during creation of view.

The mechanism has ability of push down the filter conditions of a query involving view to the compiled code.

The mechanism has ability of hook the planner/optimizer to consider the compiled view instead of expanding the view to its base query.

Although implementations for to a system and method to optimize queries on a view have been described in language specific to structural features and/or methods, it is to be understood that the appended claims are not necessarily limited to the specific features or methods described. Rather, the specific features and methods are disclosed as examples of implementations of to a system and method to optimize queries on a view.

What is claimed is:

1. A data processing method for directing a data processing system to process a query against data objects, comprising:
receiving a view creation query comprising a query definition;
creating a view based on the view creation query received;
compiling the query definition to form a structure containing schema of the view and associated elements;
generating at least one compilation function, wherein the compilation function comprises access methods to access the associated elements based on projections needed by the view;
changing a status associated with the view in a pre-stored system table; and
storing the schema of the view and the compilation function into a shared object file.

2. The data processing method as claimed in claim 1, wherein an information associated with the status of compilation is stored in system table which comprises a location of the shared object file against the view when the view is created.

3. The data processing method as claimed in claim 1, further comprising creating the structure containing schema of the view as the associated elements during compiling.

4. The data processing method as claimed in claim 1, wherein, when the query involving the view is issued, the data processing method further comprises:
looking up the status of compilation for view in the system table;
skipping planning and optimizing the view; and
directly invoking the function in the shared object to run the query with the filter conditions as a parameter to the function when the view is found in the system table.

5. The data processing method as claimed in claim 1, wherein the status is a value indicating whether the view is compiled.

6. A data processing method for directing a data processing system to process a query against data objects, comprising:
receiving a query comprising a part of query on view;
checking in system table based on the part of query on view, wherein the system table comprises a status associated with the view indicating the compilation of the view;
fetching a shared object file storing at least one compilation function associated with the part of query on view when the status indicates that the view is compiled;
using the compilation function as a part of a query execution plan; and
executing the query execution plan to display the result.

7. The data processing method as claimed in claim 6, wherein an information associated with the status of compilation is stored in system table which comprises a location of the shared object file against the view when the view is created.

8. The data processing method as claimed in claim 6, further comprising creating the structure containing schema of the view as the associated elements during compiling.

9. The data processing method as claimed in claim 6, wherein, when the query involving the view is issued, the data processing method further comprises:
looking up the status of compilation for view in the system table;
skipping planning and optimizing the view; and
directly invoking the function in the shared object to run the query with the filter conditions as a parameter to the function when the view is found in the system table.

10. The data processing method as claimed in claim 6, wherein the status is a value indicating whether the view is compiled.

11. A data processing system for processing a query against data objects, comprising:
a processor configured to:
receive a view creation query comprising a query definition;
create a view based on the view creation query received;
compile the query definition to form a structure containing schema of the view and associated elements;
generate at least one compilation function, wherein the compilation function comprises access methods to access the associated elements based on the projections needed by the view;
change a status associated with the view in a pre-stored system table, wherein the status is a value indicating the view is compiled or not compiled; and
store the schema of the view and the compilation function into a shared object file.

12. The data processing system as claimed in claim 11, wherein information associated with the status of compilation is stored in system table which comprises a location of the shared object file against the view when the view is created.

13. The data processing system as claimed in claim 11, wherein the processor is further configured to create the structure containing schema of the view as the associated elements during compiling.

14. The data processing system as claimed in claim 11, wherein, when the query involving the view is issued, the processor is further configured to:
looking up the status of compilation for view in the system table;
skipping planning and optimizing the view; and
directly invoking the function in the shared object to run the query with the filter conditions as a parameter to the function when the view is found in the system table.

15. The data processing system as claimed in claim 11, wherein the status is a value indicating whether the view is compiled.

16. A data processing system for processing a query against data objects, comprising:
a processor coupled to a memory and configured to store a plurality of instructions for directing the processor to:
receive a query comprising a part of query on view;
check in a system table based on the part of query on view, wherein the system table comprises a status associated with the view indicating the compilation of the view;
fetch a shared object file storing at least one compilation function associated with the part of query on view when the status indicates that the view is compiled;
use the compilation function as a part of a query execution plan; and
execute the query execution plan to display the result.

17. The data processing system as claimed in claim 16, wherein information associated with the status of compilation is stored in system table which comprises a location of the shared object file against the view when the view is created.

18. The data processing system as claimed in claim 16, wherein the processor is further configured to create the structure containing schema of the view as the associated elements during compiling.

19. The data processing system as claimed in claim 16, wherein, when the query involving the view is issued, the processor is further configured to:
looking up the status of compilation for view in the system table;
skipping planning and optimizing the view; and
directly invoking the function in the shared object to run the query with the filter conditions as a parameter to the function when the view is found in the system table.

20. The data processing system as claimed in claim 16, wherein the status is a value indicating whether the view is compiled.
